(19) United States
(12) Patent Application Publication
(10) Pub. No.: US 2019/0037363 A1
(43) Pub. Date: Jan. 31, 2019

(54) VEHICLE BASED ACOUSTIC ZONING SYSTEM FOR SMARTPHONES

(71) Applicant: GM Global Technology Operations LLC, Detroit, MI (US)

(72) Inventors: Eli Tzirkel-Hancock, Ra'Anana (IL); Ilan Malka, Tel Aviv (IL)

(21) Appl. No.: 15/664,629

(22) Filed: Jul. 31, 2017

(51) Int. Cl. H04W 4/04; H04R 3/12; H04W 24/08

(52) U.S. Cl. CPC H04W 4/046; H04R 3/12; H04W 76/023; H04R 2499/13; H04W 24/08

(57) ABSTRACT

An acoustic zoning system for a vehicle includes one or more speakers mounted in the vehicle, and a zoning control module that establishing one or more smartphone usage zones in the vehicle. The zoning control module includes a smartphone detection module operable to detect an audible interaction with a smartphone of at least one of a plurality of occupants of the vehicle, and a speaker control module operable to control at least one of the one or more speakers to substantially acoustically isolate the one of the plurality of occupants from another of the plurality of occupants of the vehicle.

### INTRODUCTION

The subject disclosure relates to the art of vehicles and, more particularly, to an acoustic zoning system for smartphones in a vehicle.

The use of smartphones has become ubiquitous. A person may choose to enter into a conversation at any place in which cell coverage exists. Often times, one or more passengers in a vehicle will engage in a conversation using a smartphone. In addition to passenger conversations, a driver may verbally interact with an on-board navigation system. Conversations in the vehicle may interfere with interactions with the navigation system and vice versa. Accordingly, it is desirable to provide a system that can attenuate or isolate conversations in a vehicle; be those conversations between individuals on smartphones and/or conversations between an individual and a navigation system.

### SUMMARY

In accordance with an aspect of an exemplary embodiment, an acoustic zoning system for a vehicle includes one or more speakers mounted in the vehicle, and a zoning control module that establishing one or more smartphone usage zones in the vehicle. The zoning control module includes a smartphone detection module operable to detect an audible interaction with a smartphone of at least one of a plurality of occupants of the vehicle, and a speaker control module operable to control at least one of the one or more speakers to substantially acoustically isolate the one of the plurality of occupants from another of the plurality of occupants of the vehicle.

In addition to one or more of the features described above or below, or as an alternative, further embodiments could include a microphone arranged in the vehicle for receiving audio signals.

In addition to one or more of the features described above or below, or as an alternative, further embodiments could include wherein the zoning control module includes a microphone control module operable to filter audio passing into the microphone.

In addition to one or more of the features described above or below, or as an alternative, further embodiments could include wherein the smartphone detection module is operatively connected to the microphone, the smartphone detection module being operable to identify a smartphone conversation based on audio signals received at the microphone.

In addition to one or more of the features described above or below, or as an alternative, further embodiments could include a pairing system operable to pair a smartphone with one or more vehicle systems, the smartphone detection module being operably coupled with the pairing system.

In addition to one or more of the features described above or below, or as an alternative, further embodiments could include wherein the microphone forms part of a smartphone positioned in the vehicle.

In accordance with another aspect of an exemplary embodiment, a method of establishing smartphone usage zones in a vehicle includes detecting use of a smartphone in the vehicle, determining a location of the smartphone in the vehicle, defining a smartphone usage zone at the location of the smartphone, and controlling one or more speakers in the vehicle to substantially confine audible interactions with the smartphone to the smartphone usage zone.

In addition to one or more of the features described above or below, or as an alternative, further embodiments could include controlling the one or more speakers to substantially limit exposure of acoustic emissions from other occupant zones passing into the smartphone usage zone.

In addition to one or more of the features described above or below, or as an alternative, further embodiments could include wherein detecting use of the smartphone includes capturing an image smartphone usage.

In addition to one or more of the features described above or below, or as an alternative, further embodiments could include wherein detecting use of the smartphone includes sensing smartphone usage through a vehicle-smartphone link.

In addition to one or more of the features described above or below, or as an alternative, further embodiments could include attenuating audible signals from the smartphone usage zone passing towards a driver's zone of the vehicle.

In accordance with yet another aspect of an exemplary embodiment, a computer program product for acoustically zoning a vehicle based on smartphone usage includes a non-transitory computer readable storage medium having program instructions embodied therewith. The program instructions are executable by a computer processor to cause the computer processor to detect use of a smartphone in the vehicle, determine a location of the smartphone in the vehicle, define a smartphone usage zone at the location of the smartphone, and control one or more speakers in the vehicle to substantially confine audible interactions with the smartphone to the smartphone usage zone.

In addition to one or more of the features described above or below, or as an alternative, further embodiments could include wherein the program instructions are executable by the computer processor to cause the computer processor to control the one or more speakers to substantially limit exposure of acoustic emissions from other occupant zones passing into the smartphone usage zone.

In addition to one or more of the features described above or below, or as an alternative, further embodiments could include wherein the program instructions are executable by the computer processor to cause the computer processor to capture an image of smartphone usage when detecting the use of the smartphone.

In addition to one or more of the features described above or below, or as an alternative, further embodiments could include wherein the program instructions are executable by the computer processor to cause the computer processor to filter audible signals from other occupant zones passing into a microphone of the smartphone.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including an acoustic zoning system, in accordance with an exemplary embodiment; and

FIG. 2 depicts a block diagram illustrating the acoustic zoning system, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

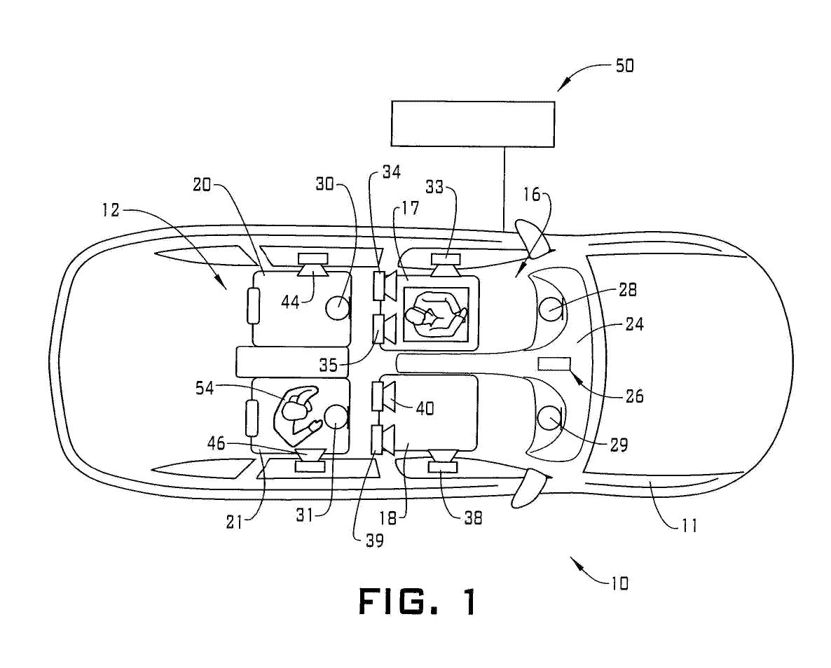

A vehicle, in accordance with an exemplary embodiment, is illustrated generally at 10 in FIG. 1. Vehicle 10 includes a body 11, including a passenger compartment 12, having a plurality of zones 16. The plurality of zones 16 may include a driver zone 17, a front occupant zone 18, a first rear occupant zone 20 and a second rear occupant zone 21. A dashboard 24 may extend across driver zone 17 and front occupant zone 18. Dashboard 24 may support a camera 26 as well as a first microphone 28 arranged in driver zone 17 and a second microphone 29 arranged in front occupant zone 18. A third microphone 30 may be arranged in first rear occupant zone 20 and a fourth microphone 31 may be arranged in second rear occupant zone 21.

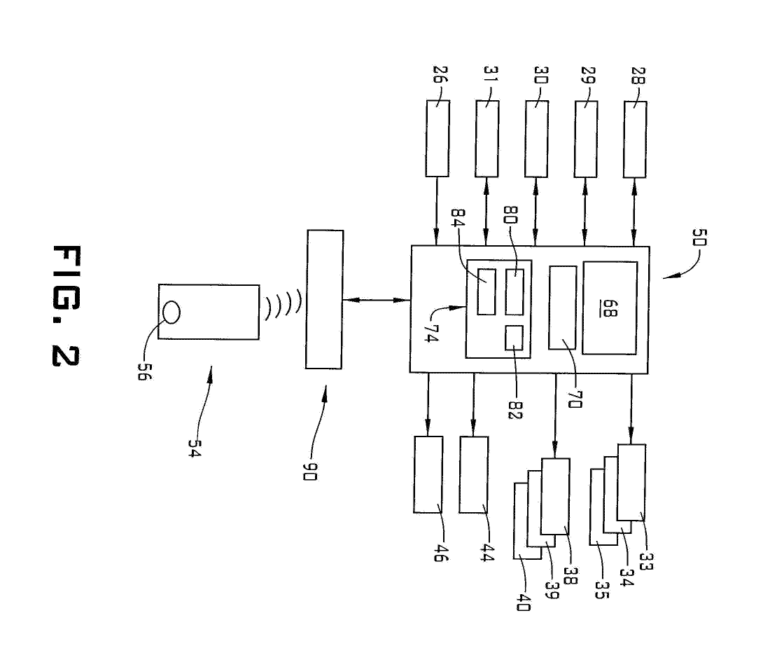

Vehicle 10 also supports a first speaker 33, a second speaker 34, and a third speaker 35 in driver zone 17. A fourth speaker 38, a fifth speaker 39, and a sixth speaker 40 are arranged in front occupant zone 18. First rear occupant zone 20 includes a seventh speaker 44 and second rear occupant zone 21 includes an eighth speaker 46. Vehicle 10 also includes an acoustic zoning system 50 that substantially acoustically limits excursions of a smartphone conversation from one or more of the plurality of zones 16 to others of the plurality of zones 16 in order to enhance interactions with, for example, vehicle interface systems that may rely on voice recognition as will be detailed herein. Specifically, acoustic zoning system 50 may detect an audible interaction with a microphone 56 (FIG. 2) of smartphone 54 in, for example, second rear occupant zone 21. Once detected, second rear occupant zone 21 may be designated as a smartphone usage zone. Audio intrusion into, and audio excursions out from the smartphone usage zone may then be reduced as will be detailed herein.

With reference to FIG. 2, and continued reference to FIG. 1, acoustic zoning system 50 includes a processor 68 and a non-volatile memory 70 having stored thereon a set of instructions to be carried out by processor 68. Acoustic zoning system 50 also includes a zoning control module 74 that defines zones within passenger compartment 12 based on smartphone use, a smartphone detection module 80 that detects smartphone usage, a speaker control module 82 that may control audio signals from one or more of speakers 33-35, 38-40, 44, and 46, and a microphone control module 84 that may receive signals from and/or filter input to one or more of microphones 28-31. Acoustic zoning system 50 may be operably connected to camera 26 and to a pairing system 90 that enables occupants in vehicle 10 to pair or establish a vehicle-smartphone link.

In accordance with an aspect of an exemplary embodiment, smartphone detection module 80 detects an interaction with a smartphone in vehicle 10. Interactions or use of a smartphone may be detected by one or more of camera 26, one or more of microphones 28-31 or through pairing system 90. For example, camera 26 may capture an image of smartphone usage by an occupant. In another example, one of microphones 28-31 may detect a conversation. In yet another example, pairing system 90 may detect an interaction with a navigation system or a conversation through a paired smartphone. In addition, smartphone detection module 80 may employ multiple devices to determine usage and usage location. For example, usage may be detected through one or more of microphones 28-31 and usage location may be detected through images captured by camera 26. It is to be understood that the above described examples are non-limiting and that additional systems may work individually or in combination to detect smartphone usage.

Once smartphone usage is detected, and a location of the smartphone usage determined, acoustic zoning system 50 establishes a smartphone usage zone. In FIG. 1, second rear occupant zone 21 could be defined as a smartphone usage zone in accordance with an exemplary aspect. At this point, zoning control module 74 may control speaker 46 and/or others of speakers 33-35, 38-40 and 44 to limit egress of a smartphone conversation from second rear occupant zone 21. For example, in the event a driver is engaged with a navigation system or other voice controlled vehicle interface (not shown), zoning control module 74 may attenuate passenger conversations in the smartphone usage zone to prevent and or reduce interference in the driver zone 17. That is, zoning control system may process signals captured by microphone 28 and/or microphone 29 to attenuate passenger conversations from interfering with another occupant(s) that may be engaged with a vehicle system.

The attenuation of the passenger conversations reduces and/or substantially eliminates interference with voice recognition systems and/or vehicle interface understanding of driver commands. It should be understood that the above describing is but an example, zoning control system may also prevent and or reduce interference with the vehicle interface in front occupant zone 18. Zoning control module 74 may also filter audio passing through microphone 56 of smartphone 54 that is paired to the vehicle interface to enhance conversational clarity.

Zoning control module 74 may also control one or more of speakers 33-35, 38-40, 44 and 46 to substantially limit ingress of audio, such as music, into the smartphone usage zone to further enhance conversational clarity without detracting from other occupants' enjoyment. As an example, with second rear occupant zone 21 being designated a smartphone usage zone, only speakers 34, 35, 39 and 40 may be in operation. At this point, it should be understood that exemplary embodiments describe a system that provides acoustic zoning in a vehicle to enable smartphone conversations without intruding on other occupant conversations, music listening and/or interactions with on-board navigation systems.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. An acoustic zoning system for a vehicle comprising:
one or more speakers mounted in the vehicle; and
a zoning control module for establishing one or more smartphone usage zones in the vehicle, the zoning control module comprising:
a smartphone detection module operable to detect an audible interaction with a smartphone of at least one of a plurality of occupants of the vehicle; and
a speaker control module operable to control at least one of the one or more speakers to substantially acoustically isolate the one of the plurality of occupants from others of the plurality of occupants of the vehicle.

2. The acoustic zoning system according to claim 1, further comprising: a microphone arranged in the vehicle for receiving audio signals.

3. The acoustic zoning system according to claim 2, wherein the zoning control module includes a microphone control module operable to filter audio passing into the microphone.

4. The acoustic zoning system according to claim 2, wherein the smartphone detection module is operatively connected to the microphone, the smartphone detection module being operable to identify a smartphone conversation based on audio signals received at the microphone.

5. The acoustic zoning system according to claim 2, further comprising: a pairing system operable to pair a smartphone with one or more vehicle systems, the smartphone detection module being operably coupled with the pairing system.

6. The acoustic zoning system according to claim 5, wherein the microphone forms part of a smartphone positioned in the vehicle.

7. A method of establishing smartphone usage zones in a vehicle comprising:
detecting use of a smartphone in the vehicle;
determining a location of the smartphone in the vehicle;
defining a smartphone usage zone at the location of the smartphone; and
controlling one or more speakers in the vehicle to substantially confine audible interactions with the smartphone to the smartphone usage zone.

8. The method of claim 7, further comprising: controlling the one or more speakers to substantially limit exposure of acoustic emissions from other occupant zones passing into the smartphone usage zone.

9. The method of claim 7, wherein detecting use of the smartphone includes capturing an image smartphone usage.

10. The method of claim 7, wherein detecting use of the smartphone includes sensing smartphone usage through a vehicle-smartphone link.

11. The method of claim 7, further comprising: attenuating audible signals from the smartphone usage zone passing towards a driver's zone of the vehicle.

12. A computer program product for acoustically zoning a vehicle based on smartphone usage, the computer program product comprising a non-transitory computer readable storage medium having program instructions embodied therewith, the program instructions being executable by a computer processor to cause the computer processor to:
detect use of a smartphone in the vehicle;
determine a location of the smartphone in the vehicle;
define a smartphone usage zone at the location of the smartphone; and
control one or more speakers in the vehicle to substantially confine audible interactions with the smartphone to the smartphone usage zone.

13. The computer program product of claim 12, wherein the program instructions are executable by the computer processor to cause the computer processor to control the one or more speakers to substantially limit exposure of acoustic emissions from other occupant zones passing into the smartphone usage zone.

14. The computer program product of claim 12, wherein the program instructions are executable by the computer processor to cause the computer processor to capture an image of smartphone usage when detecting the use of the smartphone.

15. The computer program product of claim 12, wherein the program instructions are executable by the computer processor to cause the computer processor to filter audible signals from other occupant zones passing into a microphone of the smartphone.
